(19) United States
(12) Patent Application Publication
(10) Pub. No.: US 2024/0200958 A1
(43) Pub. Date: Jun. 20, 2024

(54) VEHICLE AND TRAVELING ROUTE SETTING METHOD FOR VEHICLE

(71) Applicant: TOYOTA JIDOSHA KABUSHIKI KAISHA, Toyota-shi (JP)

(72) Inventors: Shoji SAKAMOTO, Shizuoka-ken (JP); Kazumi Tsuchiya, Gotemba-shi (JP); Makoto Matsushita, Ichinomiya-shi (JP); Takeshi Takemoto, Nagoya-shi (JP); Shunsuke Sagara, Nisshin-shi (JP); Hideaki Shiraishi, Tokyo (JP)

(73) Assignee: TOYOTA JIDOSHA KABUSHIKI KAISHA, Toyota-shi (JP)

(21) Appl. No.: 18/480,808

(22) Filed: Oct. 4, 2023

(30) Foreign Application Priority Data
Dec. 14, 2022 (JP) 2022-199497

(51) Int. Cl. G01C 21/34

(52) U.S. Cl. CPC G01C 21/3461

(57) ABSTRACT

The vehicle includes a reception device capable of receiving weather information and road information included in satellite data transmitted from an artificial satellite, and a navigation unit capable of setting a travel route between a current position and a destination. The navigation unit resets the set travel route to a new route based on the information on the linear precipitation zone and the road information included in the weather information.

### CROSS-REFERENCE TO RELATED APPLICATION

This application claims priority to Japanese Patent Application No. 2022-199497 filed on Dec. 14, 2022, incorporated herein by reference in its entirety.

### BACKGROUND

### 1. Technical Field

The present disclosure relates to a vehicle and a traveling route setting method for a vehicle.

### 2. Description of Related Art

Japanese Unexamined Patent Application Publication No. 2021-068994 (JP 2021-068994 A) discloses proposing a traveling route of a vehicle based on weather information or the like.

### SUMMARY

In JP 2021-068994 A described above, when a linear precipitation zone occurs in an area in which a vehicle is traveling, it is difficult to guide the vehicle to a safe area.

In view of the above, it is an object of the present disclosure to provide a vehicle capable of acquiring an appropriate traveling route avoiding a linear precipitation zone and a traveling route setting method for the vehicle.

A vehicle according to claim 1 includes: a reception device for receiving weather information and road information included in satellite data transmitted from an artificial satellite; and a navigation unit able to set a traveling route between a current position and a destination. The navigation unit resets the set traveling route to a new route based on information on a linear precipitation zone included in the weather information and the road information.

The reception device of the vehicle according to claim 1 can receive weather information and road information included in satellite data. The navigation unit can set a traveling route between the current position of the vehicle and the destination. Further, the navigation unit resets the set traveling route to a new route based on information on a linear precipitation zone included in the weather information and the road information. Therefore, the vehicle according to claim 1 can acquire an appropriate traveling route avoiding a linear precipitation zone.

In the vehicle of the disclosure according to claim 2, in the disclosure according to claim 1, the navigation unit determines, based on geographic information, the weather information, and the road information included in the satellite data, whether a travel prohibition area that is an area in which the vehicle is prohibited from traveling is included in the set traveling route, and resets, when determining that the travel prohibition area is included, the set traveling route to a new route that avoids the travel prohibition area.

In the disclosure according to claim 2, a route that avoids the travel prohibition area can be reset as the traveling route.

In the vehicle of the disclosure according to claim 3, in the disclosure according to claim 2, the navigation unit determines the travel prohibition area based on traffic amount information included in the road information.

In the disclosure according to claim 3, for example, when the traffic amount on one of the two roads included in the area in which the vehicle is traveling is extremely larger than the traffic amount on the other road and the moving speed of each vehicle on the one road is small, it can be determined that the one road is the travel prohibition area.

In the vehicle of the disclosure according to claim 4, in the disclosure according to any one of claims 1 to 3, the navigation unit acquires a first time at which the vehicle is expected to reach a specific area that is an area having a possibility of becoming the travel prohibition area in the traveling route, and a second time at which the specific area is expected to become the travel prohibition area, and resets the traveling route when the second time arrives earlier than the first time.

In the disclosure according to claim 4, when the second time at which the specific area that is an area having a possibility of becoming the travel prohibition area is expected to become the travel prohibition area arrives earlier than the first time at which the vehicle is expected to reach the specific area, the navigation unit resets the travel route. That is, the traveling route is reset only when the traveling route needs to be reset. Therefore, compared to the case where the traveling route is always changed in the case where the occurrence of the travel prohibition area is expected, the time until the vehicle reaches the destination is likely to be shorter.

A traveling route setting method for a vehicle according to claim 5 includes: receiving weather information and road information included in satellite data transmitted from an artificial satellite; and resetting, when a traveling route between a current position and a destination is set, the set traveling route to a new route based on information on a linear precipitation zone included in the weather information and the road information.

As described above, the vehicle and the traveling route setting method for the vehicle according to the present disclosure have an excellent effect that an appropriate traveling route avoiding a linear precipitation zone can be acquired.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating a vehicle travel guidance system including a vehicle and an artificial satellite according to an embodiment;

FIG. 2 is a control diagram of ECU of vehicles shown in FIG. 1;

FIG. 3 is a functional diagram of ECU shown in FIG. 2;

FIG. 4 is a diagram representing a display of vehicles; and

FIG. 5 is a flow chart illustrating a process executed by CPU of ECU.

### DETAILED DESCRIPTION OF EMBODIMENTS

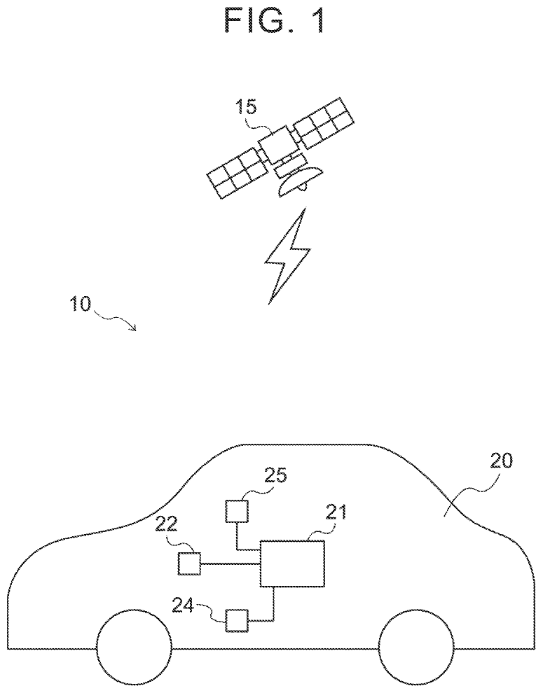

Hereinafter, an embodiment of a vehicle 20 and a traveling route setting method of the vehicle according to the present disclosure will be described with reference to the drawings. As shown in FIG. 1, vehicle 20 is part of vehicle travel guidance system 10. The vehicle travel guidance system 10 includes an artificial satellite 15 and a vehicle 20.

The artificial satellite 15 shown in FIG. 1 circulates on the earth's satellite orbit at a predetermined cycle, and photographs the earth and the sky. Therefore, the satellite data, which is the captured data acquired by the artificial satellite 15, includes, for example, geographic information on the ground, road information, and image data representing weather information. The image data representing the geographic information includes, for example, image data representing the ground and the sea. Further, the image data representing the ground includes, for example, image data representing mountains, rivers, buildings, and cultivated land. The image data representing the road information includes image data representing the position and shape of the road, and image data representing the traffic amount information (information regarding the number of vehicles and the vehicle speed of each vehicle). The image data representing the weather information includes, for example, image data representing rainfall and air temperature. Further, the image data representing rainfall includes, for example, image data representing a linear precipitation zone.

As shown in FIG. 1, the vehicle 20 includes an Electronic Control Unit (ECU) 21, a display 22 having a touch panel, a satellite-data receiver (reception device) 24, and a Global Navigation Satellite System (GNSS) receiver 25. The display 22, the satellite-data receiver 24 and GNSS receiver 25 are connected to an ECU 21.

As described below, the display 22 can display various images. The satellite data receiver 24 is capable of receiving satellite data acquired by the artificial satellite 15 and transmitted toward the ground. GNSS receiver 25 receives GNSS signals transmitted from GNSS satellites, and thereby acquires information (hereinafter, referred to as “position information”) related to the position at which the vehicles 20 are traveling.

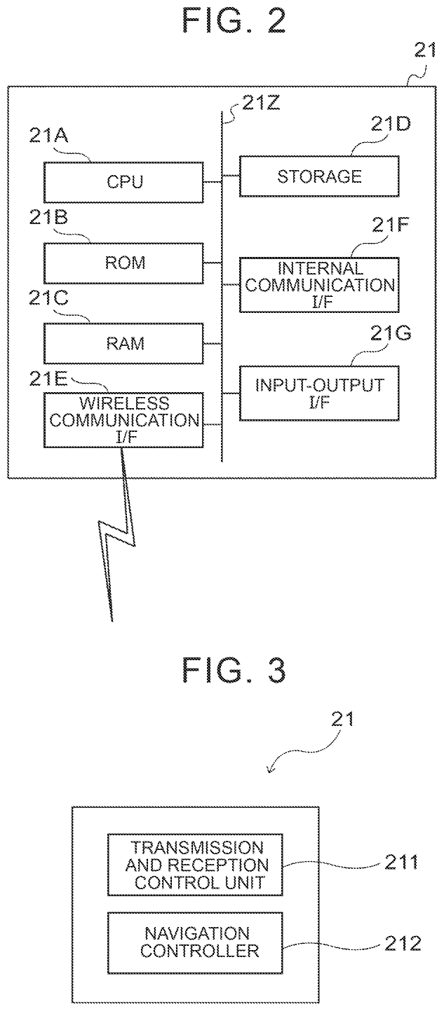

As shown in FIG. 2, ECU 21 includes a Central Processing Unit (CPU) (processor) 21A, Read Only Memory (ROM) 21B, Random Access Memory (RAM) 21C, a storage 21D, a radio communication Interface (I/F) 21E, an internal communication I/F 21F, and an input/output I/F 21G. CPU 21A, ROM 21B, RAM 21C, the storage 21D, the radio communication I/F 21E, the internal communication I/F 21F, and the input/output I/F 21G are communicably connected to each other via an internal bus 21Z. ECU 21 can acquire the time-related information from the timer. A display 22, a satellite-data receiver 24, and a GNSS receiver 25 are connected to ECU 21 (input/output I/F 21G).

CPU 21A is a central processing unit that executes various programs and controls each unit. CPU 21A reads a program from a ROM 21B or a storage 21D, and executes the program using RAM 21C as a working area. CPU 21A performs control of respective configurations and various arithmetic processes in accordance with programs recorded in a ROM 21B or a storage 21D.

ROM 21B stores various programs and various data. RAM 21C temporarily stores a program/data as a working area. The storage 21D is constituted by a storage device such as a Hard Disk Drive (HDD) or a Solid State Drive (SSD), and stores various programs and various data. For example, the storage 21D stores maps of the entire country in which the vehicles 20 are located. The map data is part of a navigation system mounted on the vehicle 20.

A wireless communication I/F 21E is an interface for wirelessly communicating with various devices. As the radio communication I/F 21E, a communication standard such as Bluetooth (registered trademark) or Wi-Fi (registered trademark) is used.

The internal communication I/F 21F is an interface for connecting to an ECU different from ECU 21 provided in the vehicles 20 via an external bus.

The input/output I/F 21G is an interface for communicating with the display 22, the satellite-data receiver 24, and GNSS receiver 25.

FIG. 3 is a block-diagram illustrating an exemplary functional configuration of ECU 21. ECU 21 includes a transmission and reception control unit 211 and a navigation control unit (navigation unit) 212 as functional configurations. The transmission and reception control unit 211 and the navigation control unit 212 are realized by CPU 21A reading and executing a program stored in ROM 21B.

The transmission and reception control unit 211 controls the radio communication I/F 21E, the internal communication I/F 21F, the satellite-data receiver 24, and GNSS receiver 25.

The navigation control unit 212 controls a navigation system mounted on the vehicle 20. For example, the navigation control unit 212 causes the display 22 to display various images including a map image represented by the map data and an image represented by satellite data (captured data). Further, the navigation control unit 212 causes the display 22 (map image) to display the travel route set by the occupant of the vehicle 20 using the display 22 (touch panel).

Further, the navigation control unit 212 acquires weather information, road information, and geographic information from the satellite data by image analysis of the satellite data received from the artificial satellite 15 by the satellite data receiver 24. Further, the navigation control unit 212 resets the set traveling route to a new traveling route when it is determined that a predetermined resetting condition is satisfied on the basis of the information on the linear precipitation zone, the road information, and the geographic information included in the weather information.

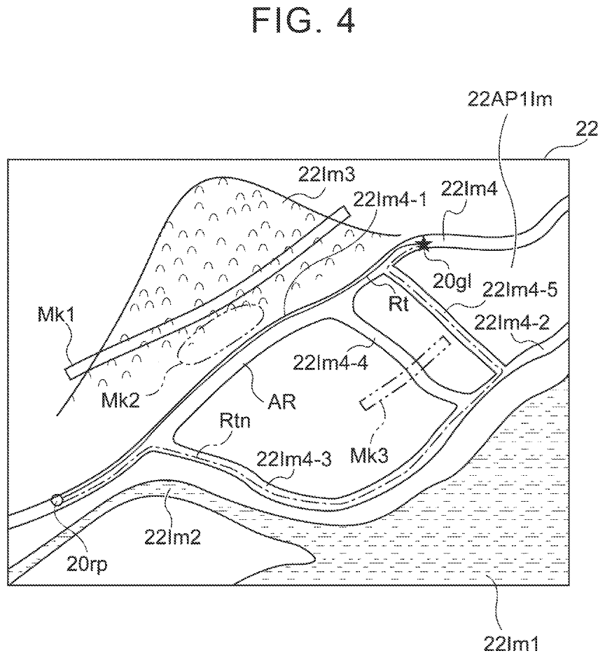

A map-image 22AP1Im of the navigation system is displayed on the display 22 illustrated in FIG. 4. The map-image 22AP1Im represents a predetermined area including the present position of the vehicles 20. The map image 22AP1Im includes, for example, an image 22Im1 representing a sea, an image 22Im2 representing a river, an image 22Im3 representing a mountain, and a road image 22Im4 representing a road. Further, the road image 22Im4 includes a road image 22Im4-1 representing a substantially straight road provided close to the mountain (image 22Im3), a road image 22Im4-2 representing a substantially straight road provided along the shore, a road image 22Im4-3 representing a substantially straight road provided along the river (image 22Im2), and two road image 22Im4-4, 22Im4-5 representing a road substantially parallel to the road (road image 22Im4-3). A circle (O) indicated by reference numeral 20rp in FIG. 4 indicates the present position of the vehicle 20. The navigation control unit 212 recognizes the current position 20rp by using the position information, and causes the display 22 to display images representing the current position 20rp. A solid line indicated by reference numeral Rt represents a travel route set using the navigation system, and a ⋆ indicated by reference numeral 20gl represents a destination of the vehicle 20.

Further, the area represented by reference numeral Mk1 in FIG. 4 represents the position of the linear precipitation zone indicated by the weather data. Further, the area represented by reference numeral Mk2 in FIG. 4 represents a landslide area that is a part of a mountain indicated by the geographic information of the satellite data and in which the landslide occurs. The image representing the linear precipitation zone Mk1 and the image representing the landslide area Mk2 may or may not be displayed on the display 22. In this case, the navigation control unit 212 determines that the landslide generated in the landslide area Mk2 affects the traveling route Rt. This landslide was caused by the linear precipitation zone Mk1. Therefore, the navigation control unit 212 determines that the predetermined area AR, which is a part of the road represented by the road image 22Im4-1, is a travel prohibited area, which is an area in which the vehicle should not travel. The road image 22Im4-3 and the road image 22Im4-4 are respectively connected to both ends of the area AR. When it is determined that there is a travel prohibition area on the traveling route Rt that has been set in this way, the reset condition is satisfied. The “region where the vehicle should not travel” is, for example, a region where there is a possibility that the vehicle cannot travel safely, a region where a traffic jam occurs, and a region where traffic restriction such as a traffic stop is performed.

In addition, the navigation control unit 212 may determine whether a traffic jam or a traffic stoppage has occurred in the road represented by the road image 22Im4-4 based on the traffic volume information included in the road information of the satellite data. For example, when the road information of the satellite data indicates that the number of vehicles located on the road indicated by the road image 22Im4-4 is extremely larger than the number of vehicles located on the road indicated by the road image 22Im4-5 and the moving velocity of the vehicles located on the road indicated by the road image 22Im4-4 is low, the navigation control unit 212 determines that a traffic jam has occurred on the road indicated by the road image 22Im4-4. Therefore, the navigation control unit 212 determines that the road represented by the road image 22Im4-4 is a travel prohibition area.

Since the reset condition is satisfied, the navigation control unit 212 cancels the set traveling route Rt, and sets a new traveling route Rtn (see the dashed-dotted line in FIG. 4) that avoids the road represented by the area AR which is the travel prohibition area and the road picture 22Im4-3 which is the travel prohibition area. When the vehicle 20 travels along the traveling route Rtn, it is highly likely that the vehicle 20 can reach the destination 20gl without being affected by sediment collapse and vehicle traffic jam (or traffic stoppage).

### Operation and Effects

Next, the operation and effects of the present embodiment will be described.

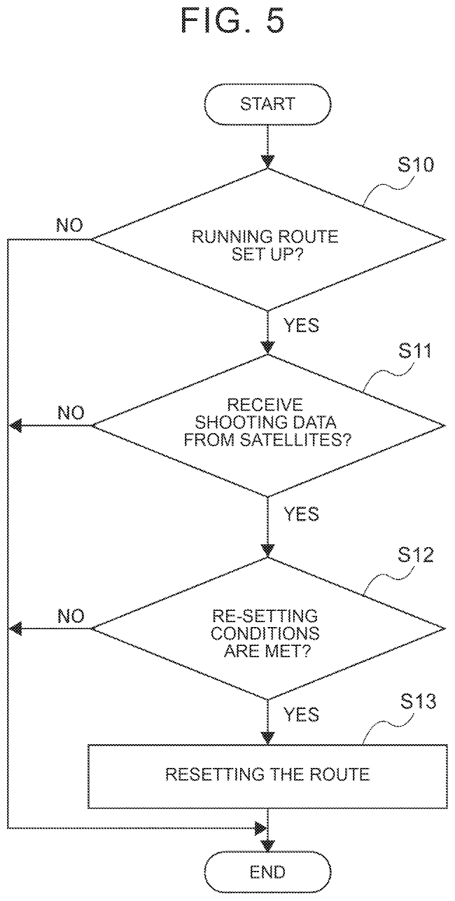

The flow of the process performed by CPU 21A of ECU 21 will be described with reference to the flow chart of FIG. 5. CPU 21A repeatedly executes the process of the flow chart of FIG. 5 every time a predetermined period elapses.

First, in S10, CPU 21A determines whether or not a travel route is set using the display 22. For example, when the traveling route Rt shown in FIG. 4 has been set, CPU 21A determines Yes in S10.

If Yes is determined in S10, CPU 21A proceeds to S11 and determines whether or not satellite data is received from the artificial satellite 15.

If it is determined in S11 that it is Yes, CPU 21A proceeds to S12 and determines whether or not the reset condition is satisfied.

If it is determined in S12 that it is Yes, CPU 21A proceeds to S13 and resets the traveling route Rtn shown in FIG. 4, for example, as a new traveling route.

When the processing of S13 is finished or when S10-12 is determined to be No, CPU 21A temporarily ends the processing of the flow chart of FIG. 6.

As described above, the vehicle 20 of the present embodiment can set the travel route between the current position and the destination. Further, the vehicles 20 can reset the set traveling route Rt to a new traveling route Rtn avoiding the travel prohibition area on the basis of the information on the linear precipitation zone, the geographic information, and the roadway information included in the weather information included in the satellite data.

Although the vehicle and the traveling route setting method of the vehicle according to the embodiment have been described above, the design of the vehicle can be appropriately changed without departing from the gist of the present disclosure.

For example, the navigation control unit 212 may reset the travel route based only on the weather information and the road information included in the satellite data. For example, the navigation control unit 212 may determine that the road represented by the road image 22Im4-4 is a travel prohibition area when the road represented by the road image 22Im4-4 shown in FIG. 4 is included in the set travel route and the linear precipitation zone represented by the code Mk3 is located on the road represented by the road image 22Im4-4. In this case, since the resetting condition is satisfied, the navigation control unit 212 resets a new travel route that avoids the road represented by the road image 22Im4-4.

Further, the navigation control unit 212 may determine, based on at least weather information and road information included in the satellite data, whether or not the traveling route includes a specific region that is a region in which there is a possibility that the traveling route becomes a travel prohibition region, and calculate a first time at which the vehicle 20 is expected to reach the specific region. The navigation control unit 212 calculates the first time based on, for example, the vehicle speed of the vehicle 20, the distance between the current position and the specific region, and the traffic amount information of the road between the current position and the specific region. Further, the navigation control unit 212 calculates a second time at which the specific area is expected to be the travel prohibition area. For example, the navigation control unit 212 calculates a second time at which the area AR as the specified area is estimated to be the travel prohibition area, based on the information indicating the landslide area Mk2 included in the geographic information of the satellite data. Furthermore, the navigation control unit 212 resets the traveling route only when the second time arrives earlier than the first time. That is, only when the travel route needs to be reset, the travel route is reset. Therefore, compared to the case where the travel route is always reset when the travel prohibition area occurs, the time until the vehicle 20 reaches the destination is likely to be shorter.

The vehicle travel guidance system 10 may include a server that receives satellite data, and the vehicle 20 may receive information related to satellite data wirelessly transmitted by the server.

What is claimed is:

1. A vehicle comprising:
a reception device for receiving weather information and road information included in satellite data transmitted from an artificial satellite; and
a navigation unit able to set a traveling route between a current position and a destination, wherein
the navigation unit resets the set traveling route to a new route based on information on a linear precipitation zone included in the weather information and the road information.

2. The vehicle according to claim 1, wherein the navigation unit
determines, based on geographic information, the weather information, and the road information included in the satellite data, whether a travel prohibition area that is an area in which the vehicle is prohibited from traveling is included in the set traveling route, and
resets, when determining that the travel prohibition area is included, the set traveling route to a new route that avoids the travel prohibition area.

3. The vehicle according to claim 2, wherein the navigation unit determines the travel prohibition area based on traffic amount information included in the road information.

4. The vehicle according to claim 2, wherein the navigation unit
acquires a first time at which the vehicle is expected to reach a specific area that is an area having a possibility of becoming the travel prohibition area in the traveling route, and a second time at which the specific area is expected to become the travel prohibition area, and
resets the traveling route when the second time arrives earlier than the first time.

5. A traveling route setting method for a vehicle, the traveling route setting method comprising:
receiving weather information and road information included in satellite data transmitted from an artificial satellite; and
resetting, when a traveling route between a current position and a destination is set, the set traveling route to a new route based on information on a linear precipitation zone included in the weather information and the road information.
